(19) United States
(12) Patent Application Publication
(10) Pub. No.: US 2020/0274482 A1
(43) Pub. Date: Aug. 27, 2020

(54) SOLAR GENERATOR

(71) Applicant: Y OUTDOOR PTY LTD, Springwood, Queensland (AU)

(72) Inventors: Bruce Parr, Springwood (AU); Alan Tame, Springwood (AU)

(21) Appl. No.: 16/646,713

(22) PCT Filed: Sep. 14, 2018
(86) PCT No.: PCT/AU2018/051002

§ 371 Date: Mar. 12, 2020

(30) Foreign Application Priority Data
Sep. 15, 2017 (AU) 2017903763

(51) Int. Cl. H02S 40/34; H02S 30/10; H02S 40/38; H02S 50/00; H05B 45/30; H05B 45/50; H02J 7/00; H02J 7/35; G09F 13/02; G09F 15/00; G09F 13/00; H01M 10/46; H01M 10/48; H01M 10/42; H01M 10/0525

(52) U.S. Cl. CPC H02S 40/34; H01M 2220/10; H02S 40/38; H02S 50/00; H05B 45/30; H05B 45/50; H02J 7/00712; H02J 7/007194; H02J 7/35; H02J 7/0013; H02J 7/00032; H02J 7/0047; G09F 13/02; G09F 15/0037; G09F 13/005; H01M 10/465; H01M 10/486; H01M 10/4257; H01M 10/0525; H02J 2207/20; H01M 2010/4271; H02S 30/10

(57) ABSTRACT

This invention relates generally to the field of solar energy renewable power supplies with energy storage and intelligent controls for powering elements of infrastructure. The solar generator has a housing having a first and a second parallel and congruent triangular end faces and rectangular faces perpendicular to the triangular faces, defining an interior volume. A base is formed on one of the rectangular faces and a solar panel is mounted on at least two of the rectangular faces for receiving the solar power energy and producing electrical potential. At least one solar charge controller is electrically connected to the solar panels and one or more rechargeable batteries are electrically connected to the at least one solar charge controller. The solar charge controller and the batteries are mounted on the base within the interior volume of the housing to form a unitary solar generator assembly.

### FIELD OF THE INVENTION

This invention relates generally to the field of solar energy renewable power supplies with energy storage and intelligent controls for powering elements of infrastructure. In particular, the present invention provides a portable or static solar generator to power various devices, appliances and equipment with or without an electrical power grid connection.

The present invention also extends to a transportable, deployable renewable energy power generator for use in remote locations and emergency situations to provide renewable power when an electrical power grid connection is not available.

It will be convenient to hereinafter describe the invention in relation to a solar generator for powering a direct current (DC) load, however it should be appreciated that the present invention is not limited to that use only and can be applied to a wide range of applications and systems.

### BACKGROUND OF THE INVENTION

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

With the rise of technology, electricity has become a resource that modern society cannot function without. Electrical power supplies must obtain the energy it supplies to its load, as well as any energy it consumes while performing that task, from an energy source. Depending on its design, a power supply may obtain energy from various types of energy sources, including electrical energy transmission systems, energy storage devices such as batteries and fuel cells, electromechanical systems such as generators and alternators, solar power converters, or another power supply.

The majority of the electrical energy transmission systems are currently provided by heat engines (steam turbines or the like) fueled by combustion of fossil fuels (coal, oil and/or natural gas). A number of problems exist with the current technologies available. These resources which provide electricity, such as coal and fossil fuels are expensive and finite. Additionally, current sources for electricity may be stationary and inconvenient to access. Furthermore, shortages and power outages can render conventional electrical sources ineffective. The supply of electricity to remote areas has always been a challenge for utilities mainly due to the cost of maintaining remote infrastructure which is much higher per customer than in more densely populated urban areas.

Due to the above problems alternative energy sources are becoming increasingly important. Among such alternative energy sources, solar energy generation is proving to be an important primary source of energy. Solar energy may be generated by solar panels, which include semiconductor materials configured in a solar cell to generate electrical energy. Many electrical devices are provided with electrical energy from renewable energy sources, such as solar. A power generator, such as a solar panel provides electrical energy for the device. To compensate for time periods when power is not being generated (e.g., during periods of darkness), an energy storage device, such as a battery, is typically employed to power the device. The amount of time that the device can be powered by the battery depends on factors such as the capacity of the battery, the power demanded by the load, and the amount of energy that is stored in the battery when the solar power generator is active (i.e., during daylight hours).

Solar power systems are subject to geographic and climatological limitations. The solar power systems are also subject to variable and unpredictable changes or interruptions of output power. In order to optimise the amount of time that the device can be powered designers have typically selected a battery capacity based on the expected service conditions of the device. However this becomes problematic during abnormal environmental conditions, such as prolonged bad weather. Increasing the battery capacity to broaden the range of environmental conditions under which the system may maintain an adequate charge increases the weight and cost of the battery. Other techniques for optimising the amount of time that the device can be powered include using sensors to turn the loads automatically on and off when not used, using monitoring equipment to monitor battery voltage or providing loads which operate at relatively low power levels.

The output of the solar panel varies with changes in illumination and temperature. The combination of voltage and current that allows a solar panel to produce its maximum power is termed the maximum power point. The maximum power point varies with cell illumination and temperature. Other factors that affect the output of a solar panel include shading, orientation and the age of the panel. The efficiency of a solar panel will degrade over time and shade will obviously affect the output of solar panels. Orientation of the panels is also important with the more time that the solar panel is exposed to the sunlight increases the charge time for the batteries.

The current systems available to power a load with a renewable energy source such as a solar power generator contain their share of problems. They can be inconveniently assembled as multiple pieces, as opposed to a set unit. They are also either immovable or difficult move. If solar power generators are portable, they tend to run out quickly and are unable to provide vast amounts of power for larger-scale needs.

A number of problems exist in providing a constant supply of grid fed power and some of these problems can cause power outages and include occurrences such as, but not limited to, storms, earthquakes, accidents and power shortages. In these situations emergency power is very desirable and sometimes necessary. One source of emergency power is the fuel powered generator or portable generator. Typically these are the combination of an electrical generator and an engine (prime mover) mounted together to form a single piece of equipment. However, generators have a number of shortcomings. For example, with generators there are issues such as, but not limited to, noise, fuel fumes and spills, carbon monoxide, and limited fuel capacity.

During emergency relief situations, military deployment situations, on construction sites, and in remote locations far from population centres, there will always be problems with the supply of reliable power and water treatment solutions. More than often we rely on gasoline powered generators to provide temporary power, but this is an extremely inefficient method. Small portable solar-powered systems have been created for charging small electronic devices but these systems have limited use. What is needed is a way to transport a means for generating a large amount of electrical power solutions at an isolated location quickly.

Clearly it would be advantageous if a solar generator with energy storage and intelligent controls for powering elements of infrastructure could be devised that helped to at least ameliorate some of the shortcomings described above. In particular, it would be beneficial if a solar power generator suitable for powering various devices, appliances and equipment with or without an electrical power grid connection was devised or to at least provide a useful alternative

### SUMMARY OF THE INVENTION

In accordance with a first aspect, the present invention provides a solar generator for converting solar power energy into electrical power, the solar generator comprising: a housing having a first and a second parallel and congruent triangular end faces and rectangular faces perpendicular to the triangular faces, defining an interior volume; a base formed on one of the rectangular faces; a solar panel mounted on at least two of the rectangular faces for receiving the solar power energy and producing electrical potential; at least one solar charge controller electrically connected to the solar panels; one or more rechargeable batteries electrically connected to the at least one solar charge controller; a power outlet electrically connected to the at least one solar charge controller, wherein the power outlet is adapted to distribute electricity stored within the one or more rechargeable batteries; and wherein the at least one solar charge controller and the batteries are mounted on the base within the interior volume of the housing to form a unitary solar generator assembly.

Preferably, the housing may be shaped as a right triangular prism with two equal length sides extending from the base. The solar panels may be mounted to the two equal length sides of the right triangular prism.

Preferably, the base may be adapted to allow the solar generator to be mounted to a mounting assembly, the mounting assembly being attached to an infrastructure. The mounting assembly may comprise a frame and at least one bracket for mounting the frame to the infrastructure. The base and frame may have complementary locking devices adapted to secure the base and the solar generator to the frame.

Alternatively, the mounting assembly may comprise a spigot mounted to the base for attaching the base to a complementary socket mounted on the infrastructure. The spigot and socket further comprise a locking mechanism to securely retain the solar generator to the infrastructure.

Preferably, the base and at least one of the triangular faces may further comprise a plurality of apertures to allow airflow through the housing to ensure an internal temperature of the batteries and the at least one solar charger controller are maintained at an acceptable level.

Preferably, the solar generator may further comprise an insect screen covering all internal faces of the housing to prevent the ingress of insects into the interior volume of the solar generator.

Preferably, the housing of the unitary solar generator may have an ingress protection rating of IP67.

Preferably, an apex is formed between the mounted solar panels, the apex may be adapted to receive an animal deterrent mechanism. The animal deterrent mechanism may be a bird wire.

Preferably, the solar panels may comprise a plurality of solar cells, the solar cells being either a monocrystalline or polycrystalline cells. The solar panels may have a tempered glass top layer and are mounted into an aluminium frame for strength and waterproofing.

Preferably, the housing may be constructed from an aluminium extruded frame, the frame being adapted to receive the solar panels, the base and the triangular end faces to form the housing with the internal volume.

Preferably, the one or more rechargeable batteries may be a lithium-ion polymer battery or the like. The rechargeable batteries may further comprise at least one temperature sensor, the temperature sensor being adapted to prevent the overheating of the batteries due to overcharging of the batteries.

Preferably, the at least one solar charge controller may be adapted to regulate the voltage of the electricity supplied to the one or more rechargeable batteries.

Preferably, the at least one solar charge controller may comprise: a microcontroller with a microprocessor and memory; a regulator for controlling the charge to the rechargeable batteries; a monitoring system adapted to monitor the voltage and current from the solar panels, monitor the voltage and current on the batteries, monitor the temperature of the batteries and control the charge and discharge of the batteries by monitoring a load connected to the power outlet; and an on/off switch or circuit breaker for isolating the solar generator.

Preferably, the microcontroller may further comprise at least one input/output port to allow a user to perform a firmware update.

Preferably, the regulator may be a buck-boost converter that has an output voltage magnitude supplied to the rechargeable batteries that is either greater than or less than the input voltage from the solar panels.

Preferably, the on/off switch or circuit breaker for isolating the solar generator may be a mechanical switch located on an outer surface of the housing. The mechanical switch may be located in one of the triangular end faces of the housing.

Alternatively, the on/off switch for isolating the solar generator may be an electronic switch which is adapted to be remotely controlled.

Preferably, the microcontroller may be a Wi-Fi 3G/4G microcontroller that enables wireless local area networking connectivity for the solar generator to send and receive data and accept commands over the internet.

Preferably, the at least one solar charge controller may further comprise a driver circuit adapted to control the voltage to the power outlet. The driver circuit may be a DC to DC converter designed as a step up or a step down voltage controller to the power outlet. The driver circuit may be an LED driver circuit configured to provide stored electrical energy from the rechargeable batteries to at least one LED, the LED driver circuit being configured to prevent overdriving of the at least one LED, and also configured to decrease the LED brightness when the voltage supplied from the rechargeable batteries drops below a predetermined voltage level. The LED driver circuit may comprise an under voltage protection circuit configured to shut off operation of the at least one LED when a voltage from the rechargeable batteries drops below a predetermined voltage level.

Preferably, the at least one solar charge controller may further comprise a wireless communication receiver for connecting the solar generator to the internet.

Preferably, the power outlet of the solar generator may be provided with a DC voltage to a load. The load may be selected from any one or more of the group consisting of: (i) an LED light; (ii) a DC to AC inverter; or (iii) any DC powered load.

Preferably, the solar generator may further comprise a GPS receiver that is capable of receiving information from a GPS satellite to calculate the solar generators geographical position.

Preferably, the solar generator may further comprise a wireless communications connection to allow the solar generator to send and receive data and receive control commands over the internet. The wireless connection may be provided by any one of a Bluetooth connection through a Bluetooth radio, a wireless local area network transceiver using a Wi-Fi connection or a microwave connection using a microwave transceiver.

Preferably, the solar generator may further comprise application software residing on a mobile computing device, the application software is adapted to i) send and receive data from the solar generator monitoring system, (ii) send control commands to the solar generator, (iii) receive information from the GPS receiver to calculate the solar generators geographical position, and (iv) update the firmware on the microcontroller.

In accordance with a further aspect, the present invention provides an outdoor advertising structure comprising at least one solar generator in accordance with any one of the features of the first aspect, the outdoor advertising structure comprising: a support structure; a display surface mounted on the support structure, the display surface having an upper edge and a lower edge and visual media content is displayed thereon; at least one light attachment means extending from the upper edge of the display surface; and at least one light emitting diode (LED) light adapted to be attached to an end of the light attachment means and powered by the solar generator and arranged to direct light across the display surface.

Preferably, the support structure may comprise at least one pole or post supported in the ground or mounted to another supporting structure.

Preferably, the at least one solar generator may be mounted to the upper edge of the display surface. Alternatively, the at least one solar generator may be mounted to the at least one pole or post or another support structure. At least one solar generator may be mounted to the pole or post by a mounting assembly, the mounting assembly may comprise a frame and at least one bracket for mounting the frame to the pole or post.

Preferably, the base or the solar generator and the frame may have complementary locking devices adapted to secure the solar generator to the frame.

Preferably, the solar generator charge controller may be configured to monitor the total amount of solar energy supplied to the rechargeable batteries during daytime and configured to calculate an amount of electrical power to be supplied from the rechargeable batteries to the at least one LED light so that the at least one LED light operates at a relatively constant level of LED output brightness during substantially all the entire night time hours.

Preferably, the outdoor advertising structure may be connected to an AC power supply.

Preferably, the outdoor advertising structure may be a digital billboard, the digital billboard being powered by the at least one solar generator and/or the AC power supply.

In accordance with a still further aspect, the present invention provides a method of illuminating an outdoor advertising structure comprising: generating electrical energy during a day with a solar generator in accordance with any one of the features of the first aspect, storing the generated electrical energy in one or more rechargeable batteries; powering at least one light emitting diode (LED) light during substantially all or part of the night time hours that follow the day time charging hours by utilising the electrical energy stored in the one or more rechargeable batteries; and wherein the at least one LED light illuminates a display surface mounted on a support structure, the display surface having visual media content displayed thereon.

In accordance with a still further aspect, the present invention provides a method of providing emergency power comprising: generating electrical energy during a day with a solar generator in accordance with any one of the features of the first aspect; storing the generated electrical energy in one or more rechargeable batteries; and powering a DC load during substantially all the night time hours that follow the day time charging hours by utilising the electrical energy stored in the one or more rechargeable batteries.

Preferably, the method may further comprise providing a DC to AC inverter to power any AC loads.

Any one or more of the above embodiments or preferred features can be combined with any one or more of the above aspects.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 shows an exploded perspective view of a solar generator in accordance with an embodiment of the present invention;

FIG. 2 shows a further view of the solar generator of FIG. 1 with some components removed for clarity of the underlying structures;

FIG. 3 shows an assembled perspective view of the solar generator of FIG. 1;

FIG. 4 illustrates a perspective view from below of the assembled solar generator of FIG. 3;

FIGS. 5 to 8 show bottom, end and side views of the assembled solar generator of FIG. 3;

FIG. 9 shows an overview block diagram for the solar generator in accordance with an embodiment of the present invention;

FIG. 10 shows a detailed block diagram of the controller and its connection to the other components of the solar generator;

FIG. 11 illustrates the solar generator exposed to an illumination source;

FIG. 12 shows a graph of the output from the solar generator of the present invention when exposed to the illumination source overtime, FIG. 12 also shows a comparative output from a standard flat solar generator;

FIGS. 13 to 28 show some exemplary uses of the solar generator in accordance with the present invention on billboards powering a light source(s);

FIGS. 29 to 34 illustrate a mounting assembly used for the solar generator on the billboards of FIGS. 13 to 28;

FIG. 35 illustrates another exemplary use of the solar generator in accordance with the present invention used as an emergency power source supplying power to a home; and

FIG. 36 shows some of the typical electrical components which can be powered by the solar generator in accordance with the present invention.

### DETAILED DESCRIPTION

The following description, given by way of example only, is described in order to provide a more precise understanding of the subject matter of a preferred embodiment or embodiments.

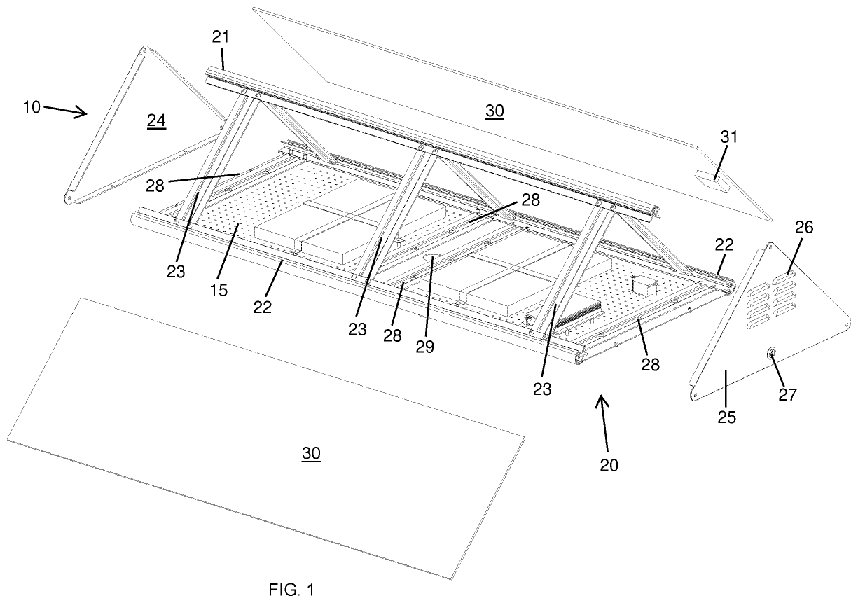

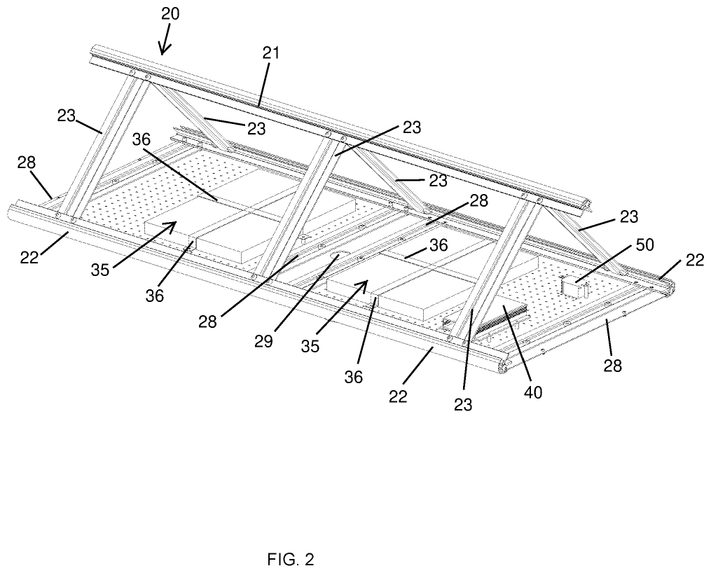

In its broadest form and as illustrated in FIGS. 1 and 2, the present invention provides a solar generator 10 for converting solar power energy into electrical power. The solar generator 10 has a housing 20 designed in the shape of a right triangular prism. The housing has a first and a second parallel and congruent triangular end faces 24, 25 and rectangular faces perpendicular to the triangular faces 24, 25, defining an interior volume. A base 15 is formed on one of the rectangular faces and houses the batteries 35, the solar charge controller 40 and Bluetooth radio 50. A solar panel 30 is mounted on two of the rectangular faces for receiving the solar power energy and producing electrical potential. The back side of the solar panels 30 show a connector block 31 for attaching the associated wiring to connect the solar panels 30 to the one or more solar charge controllers 40. The solar charge controller 40 is electrically connected to the solar panels 30. One or more rechargeable batteries 35 is/are electrically connected to the solar charge controller 40. A power outlet (not shown) is also electrically connected to the solar charge controller 40 to distribute electricity stored within the one or more rechargeable batteries 35. The solar charge controller 40 and the batteries 35 are mounted on the base 15 within the interior volume of the housing 20 and along with the solar panels 30 enclose the housing 20 to form a unitary solar generator assembly 10.

The solar panels 30 comprise a number of monocrystalline or polycrystalline cells joined to form the solar panel 30. Each panel 30 produces an output in watts and is dependent upon a number of factors. The amount of energy that a solar panel 30 receives from sunlight over a day is expressed in peak sun hours. As the amount of energy generated by a panel is directly proportional to the amount of energy it receives from sunlight, it is important to install panels so they receive maximum sunlight. The wattage of each solar panel 30 specifies its maximum output over an hour (the electricity the solar system generates is measured in kilowatt hours). By way of example only, if you have four 250 W panels (making a total of 1 kW of panels), then the maximum output these panels can generate is 1 kW over an hour. However, panels will never run at 100 percent efficiency. Losses occur through cabling and at the charge controller and will be affected by factors such as location, climate, time of year and the angle which the panels form to the direct sunlight.

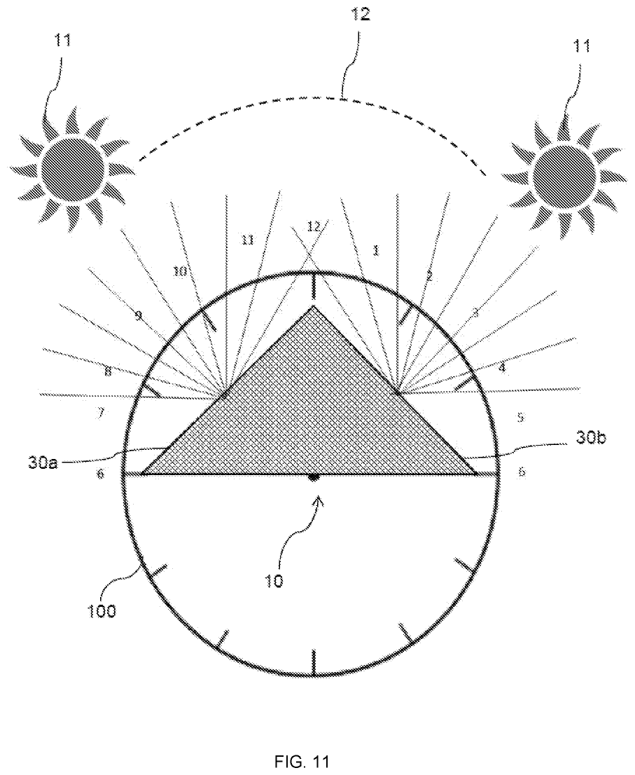

The present invention has been designed to minimise these losses to provide the best possible output for the solar generator 10 by placing the solar panels 30 on the equal length sides of a right triangular prism. This will be illustrated below in FIG. 11.

The rechargeable batteries 35 are required to be lightweight, have a large capacity and be easily recharged. By way of example only and by no way limiting to the invention, a lithium-ion polymer battery (LiPo) which uses a polymer electrolyte instead of a liquid electrolyte can be utilised. High conductivity semisolid (gel) polymers form the electrolyte and provide a rechargeable battery 35 with a higher specific energy than other lithium-battery types and therefore much lighter in weight than other rechargeable batteries. While the LiPo rechargeable battery has been described other types of rechargeable batteries 35 could also be used without departing from the present invention. For example, other types of rechargeable batteries 35 such as nickel-cadmium batteries or nickel-metal hydride batteries could be used. By way of example only, the rechargeable batteries 35 may be either a 60 AH or 80 AH battery.

FIG. 1 shows an exploded view of the solar generator assembly 10 and FIG. 2 shows the solar generator with some of the components including the end faces 24, 25 and solar panels 30 removed for clarity of the underlying structures.

The housing 20 is formed from an aluminium extruded frame. The frame 20 consists of three longitudinally extending rails 21, 22 which form the edges of the three rectangular sides of the housing 20. The extruded rail member 21 forms the apex of the housing 20 with the other two extruded rail members 22 forming the sides of the base 15. The rail members 21, 22 are joined by side members 23 and end cross members 28 to form the frame of the housing 20. A further two cross members 28 are located adjacent the wiring access aperture 29 located substantially in the middle of the base 15.

Each triangular shaped end 24, 25 is received within and secured by fasteners 16 to the ends of the extruded rail members 21, 22 to close off the ends of the housing 20. One of the triangular ends 25 has vents 26 for allowing airflow to pass therethrough and also a mounting hole for receiving the on/off switch 27. The solar panels 30 are designed to close off the remaining two rectangular sides of the housing 20. The solar panels 30 are formed in an aluminium frame with a top side of toughened or tempered glass to provide a strong waterproof panel 30. The solar panels 30 are located and retained within the side edges of the extruded rail members 21, 22 and the back side of the solar panels 30 rest upon the side members 23 of the housing 20.

The base 15 forms the final rectangular face of the right triangular prism of the housing 20. The base 15 has a plurality of perforations to allow airflow to move through the enclosed housing to provide a conduit for heat generated by the components within the housing 20 to be removed through the vents 26 in the end 25. The batteries 35 are retained to the base 15 by battery brackets 36 which pass over the batteries 35 and are secured to the base 15 by screw fasteners or the like. Likewise the solar charge controller 40 and the Bluetooth radio 50 are also secured to the base 15 by screw fasteners or the like.

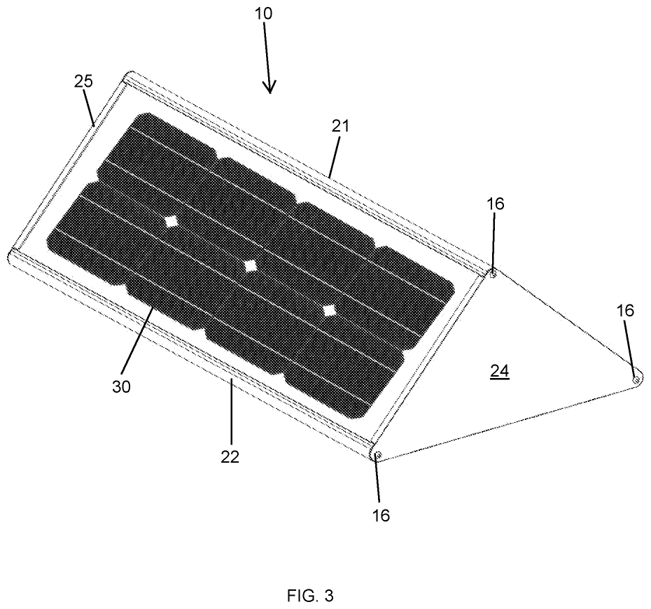

As is illustrated in FIGS. 3 and 7 the solar generator 10 and the housing 20 is formed as a right triangular prism with three rectangular sides formed by the base 15 and the solar panels 30 and the triangular ends 24, 25. The triangular ends 24, 25 are secured to the rail members 21, 22 by fasteners 16. An edge extends substantially around the periphery of each triangular end 24, 25, the edge being adapted to fit over an end of each solar panel 30 and the edge of the base 15. A right triangular prism is a prism with two parallel and congruent triangular faces 24, 25 and three rectangular faces 15, 30 formed perpendicular to the triangular faces 24, 25. In FIG. 7 the angles represented by reference numeral A show the angle which the solar panels 30 form with respect to the base 15. The angle A which the solar panels 30 form with respect to the base 15 is approximately 45 degrees. The angle represented by reference numeral B shows the angle formed between the rectangular faces of the solar panels 30 of the housing 20. The angle B which is formed between each face of the solar panel 30 is approximately 90 degrees.

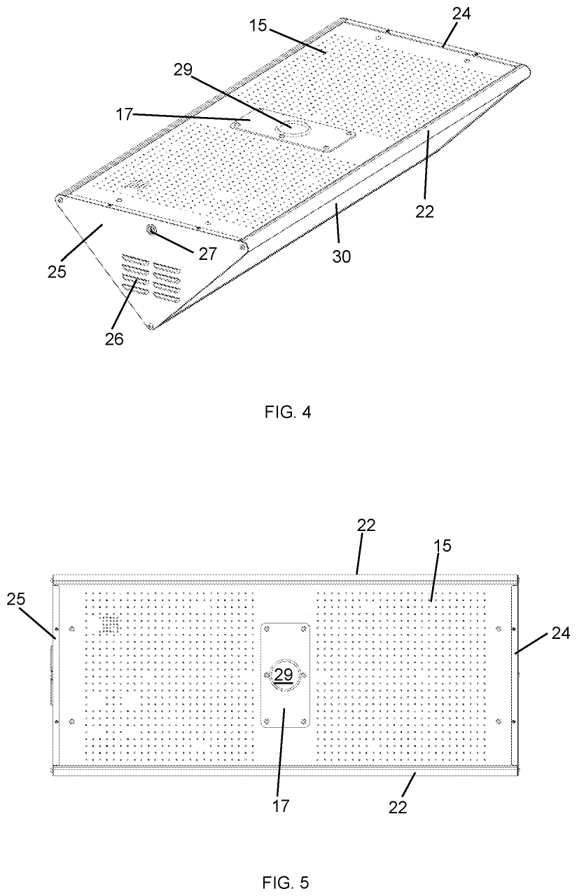

FIGS. 4 to 8 show a perspective view of the solar generator 10 from below, and bottom, end and side views of the solar generator 10. The base 15 is perforated as described above, and further includes an insect screen (not shown) located over the openings in the housing 20 to prevent the ingress of insects or animals into the solar generator 10. The insect screen is used to line the interior of the solar generator 10 to prevent the ingress of insects. Also not illustrated is a bird wire attached to the top rail 21 to prevent birds from landing on the top of the solar generator 10 and therefore preventing any associated bird droppings from forming on the solar panels 30.

The solar generator housing 20 is an IP67 rated housing. This basically means that the international protection marking of the solar generator 10 is designed to withstand the ingress of dust, general dirt and sand and also the ingress of water in harmful quantity shall not be possible when the housing 20 is immersed in water under defined conditions of pressure and time (up to 1 m of submersion).

On the bottom of the base 15 and supported around the central wiring aperture 29 is a mounting plate 17. The mounting plate 17 may be utilised to attach a spigot (not shown) for mounting the solar generator 10 to a post. The post would have a complementary socket for receiving the spigot and may also include some form of locking mechanism to secure and prevent theft of the solar generator 10.

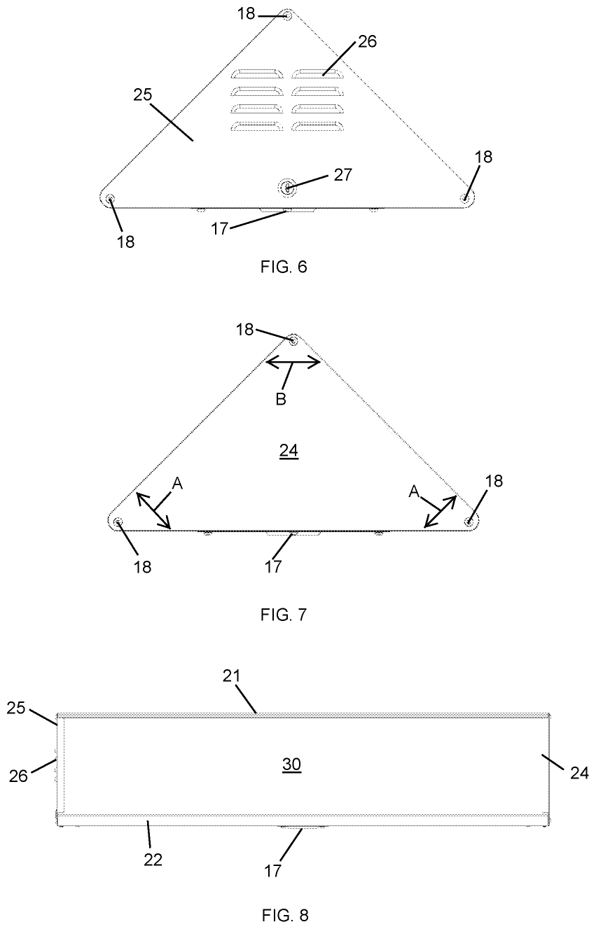

FIGS. 6 and 7 show the triangular ends 24, 25 with the fastener apertures 18 for receiving the fasteners 16 to secure the ends 24, 25 to the rails 21, 22 of the housing 20. Also shown in FIG. 6 is the mechanical on/off switch 27 for isolating the solar generator 10 from a load by disconnecting the solar charge controller 40 to isolate the output of the solar panels 30 from the load. As illustrated this may be a simple key operated switch 27 or the like. Alternatively the on/off switch may be an electronic switch associated with the microcontroller 41 of the solar charge controller 40, which will be described in further detail below.

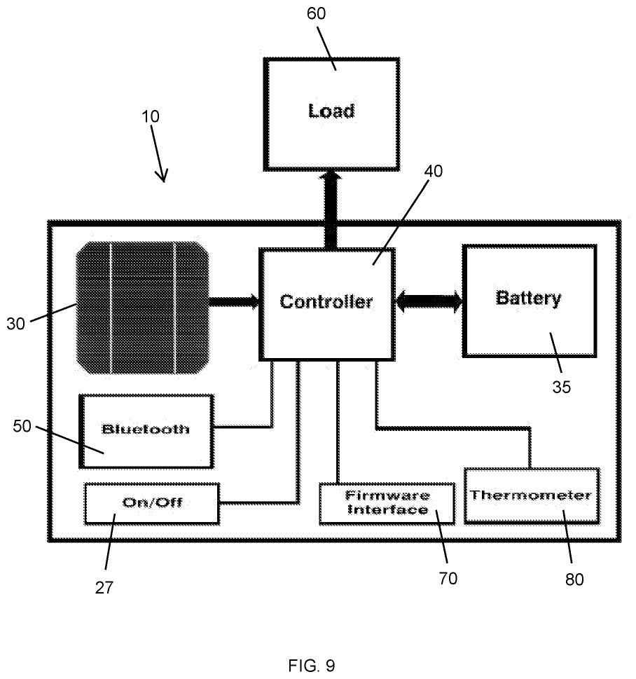

FIG. 9 shows a simplified block diagram of the components and their connections in the solar generator 10. The solar panels 30 are electrically connected to the solar charge controller 40 which regulates the charge on the batteries 35. The charge controller 40 also distributes electricity stored within the one or more rechargeable batteries 35 to the load 60. A temperature sensor 80 is used to monitor the temperature of the batteries 35 to prevent any over temperature conditions which could be induced due to the over-charging of the batteries 35. Effectively the temperature sensor 80 would isolate the output of the charge controller 40 from the batteries 35. Also shown in FIG. 9 are the on/off switch 27, the Bluetooth radio 50 and the firmware interface 70. The firmware interface 70 allows a user to update, reset or modify the software located in the solar charge controller 40. This software updates can be by a wired connection such as a USB connection on the solar generator 10 or remotely using the wireless communications interface.

The solar generator 10 may also include a global positioning system (GPS) receiver (not shown). The GPS receiver is a device that is capable of receiving information from GPS satellites and then to calculate the solar generator's 10 geographical position. The geographical position of the solar generator 10 can then be transmitted using the wireless communication system to provide the location to a user. This is ideal for locating the solar generator 10 should the device be stolen and to assist in combatting theft. The GPS uses a global navigation satellite system (GNSS) made up of a network of satellites orbiting the Earth and the GPS receiver requires four or more satellites to accurately calculate the position of the solar generator 10.

Alternatively, the microcontroller 41 of the solar charge controller 40 may include a GPS transceiver.

The Bluetooth radio 50 is a low-power wireless connectivity technology used to transfer data and broadcast information between devices over short distances. Bluetooth is a standard wireless communications protocol designed for low-power consumption, with a short range based on low-cost transceivers. As the devices use a radio (broadcast) communications system, they do not have to be in visual line of sight of each other; however, a quasi-optical wireless path must be viable. The wireless communications system allows a user to connect wirelessly to the solar generator 10 to enable the user to perform such tasks as data logging and reporting, control demands and troubleshooting. The software application described below allows a user to communicate with the solar generator 10 to perform the above tasks but also numerous other tasks which a person skilled in the art would understand and therefore are included in the present invention.

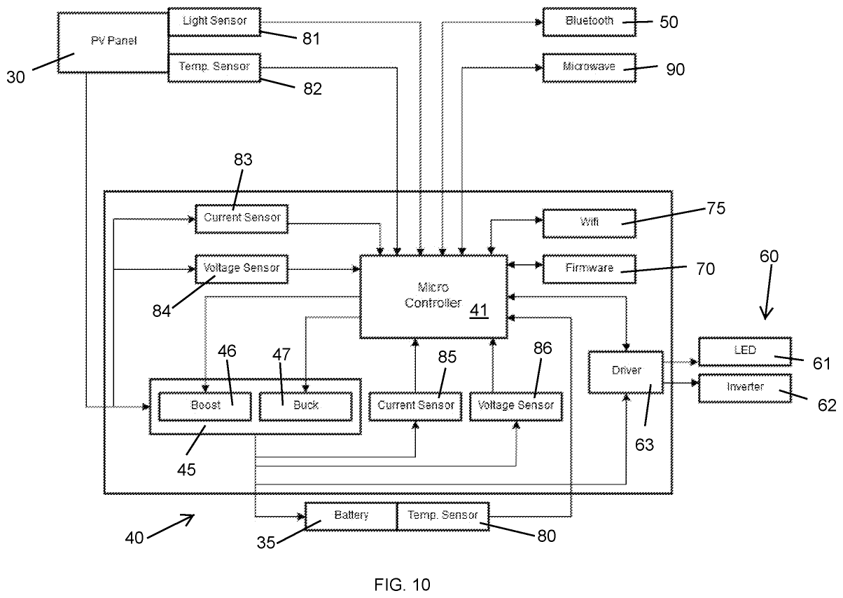

FIG. 10 illustrates an embodiment of the charge controller 40 in accordance with the present invention. In this embodiment the charge controller 40 is formed using a microcontroller 41. The microcontroller 41 is a single chip micro-computer made through very large scale (VLSI) fabrication. The microcontroller 41 has a central processing unit, memory, input/output ports, clock/timer, and is user programmable to provide a customised solar charge controller 40. The microcontroller 41 receives various inputs and outputs from the solar panels 30, the rechargeable batteries 35, the load 60 and/or the load driver 63 and the voltage regulator 45.

The microcontroller 41 allows optimisation of the solar generator 10 system through programming. For example, the overall charging efficiency depends on the efficiency of the solar panel cells. The microcontroller 41 can be utilised to incorporate a maximum power point tracking (MPPT) profile into the power-conversion algorithm to further optimise the solar generator 10. This can allow the use of a smaller solar panel 30 to meet charge objectives. This is further optimised through the orientation of the solar panels 30 on the right triangular prism housing 20 to take advantage of direct sunlight for a longer period of time. The solar generator 10 could incorporate more than one charge controller 40 and more than one associated microcontroller 41. This may be beneficial in allocating a single controller 40 to each battery 35 or simply for redundancy to avoid any downtime in the solar generator 10 due to failure of a single item.

The power from the solar panels 30 is fed to charge controller 40, which is output to the rechargeable battery 35 where energy is stored. A load 60 is present at the outlet of battery 35 to access stored power. A DC to DC converter 45 is present inside the charge controller 40 to match the solar panel 30 voltage to battery 35 voltage. A microcontroller 41 is programmed to always output maximum power. It performs this work by taking input voltage and current from solar panels 30, output voltage and current from DC to DC converter, irradiance levels from light sensor 81 and temperature from temperature sensor 82. An additional feature provided by the microcontroller 41 is the ability to transmit data from the microcontroller 41 to a remote location via RS485 interface so that this functionality aids in remotely monitoring and logging the data. The RS485 interface is a standard defining the electrical characteristics of drivers and receivers for use in serial communications systems.

The microcontroller 41 also includes a wireless communications interface for connecting the solar charge controller 40 and the solar generator 10 to send and receive data and control command over the internet. The wireless communications interface or wireless connection is provided by any one of a Bluetooth connection through a Bluetooth radio 50, a wireless local area network transceiver using a Wi-Fi connection 75 or a microwave connection using a microwave transceiver 90. Any of the above wireless connections can be utilised to control the solar generator 10 using application software residing on a mobile computing device (not shown). The application software is adapted to i) send and receive data from the solar generator monitoring system, (ii) send control commands to the solar generator 10, (iii) receive information from the GPS receiver to calculate the solar generators geographical position, and (iv) update the firmware 70 on the microcontroller 41.

Alternatively, the firmware 70 can be updated by a user connecting to one of the input/output ports on the microcontroller 41. This could be by a wired connection such as a USB port (not shown) located on the solar generator 10. The software application can also be used to download report logs and produce operational data reports such as battery condition reports, solar panel data and overall system operation reports. The system operation reports can include checking the status of each system within the solar generator 10 and produce system load reports which can be used to identify any issues with or problems in the load 60. For example, the load reports could be used to identify a non-operating LED 61 or other non-functioning or faulty load 60.

The software application can also be used to manually turn the solar generator 10 on and off or to amend the on/off time programmed in the microcontroller 41. The software application can also be utilised to reset the timer/clock, adjust the timer/clock for different time zones or for different times of the year. The programmed on/off time can be set based on standard requirements for the area of operation of the solar generator 10. For example, for a remote located billboard with lighting the on/off times may be based on a turn off time in the morning and a corresponding turn on time in the afternoon. The internal clock/timer of the microcontroller 41 is used to set the operating times for the solar generator 10. The application software can also be used to adjust the operating voltage or current of the load 60. For example the brightness of the LED 61 could be adjusted to either increase or decrease the output of the LED 61 to vary the load on the batteries 35 in conditions where low levels of light are available or have been sustained due to poor weather conditions.

The software application can be used on any mobile computing device and is compatible with both Android and iOS operating systems.

The operation of the solar generator 10 requires a monitoring system to ensure each component of the solar generator 10 is operating correctly or within the required specifications. The monitoring system comprises but is not only limited to solar panel light and temperature sensors 81, 82, solar panel voltage and current sensors 83, 84, and battery temperature, current, and voltage sensors 80, 85, 86. Also, the solar generator 10 may also include load voltage and current sensors. By way of example only, the solar panel light sensor 81 may be a photosensor or photodetector which senses light and converts the light photons into current. The photosensor could be a photodiode, photoresistor or a photo transistor. Likewise the temperature sensor 82 may be a thermistor or thermocouple which measures the temperature of a surface of the solar panel 30 by direct contact. The temperature sensor 80 is used to monitor the temperature of the batteries 35 for maximum charging. The sensor 80 monitors the temperature of the batteries 35 to prevent overheating and therefore prevent a reduction in the charge rate of the batteries 35.

The voltage and current sensors 83, 84, 85, 86 are typically voltage divider networks for the voltage sensors 84, 86 and a shunt resistor with a difference amplifier to amplify voltage appearing across the shunt resistor for the current sensors 83, 85. Alternatively, the current sensors may be a hall effect sensor which is a transducer that varies its output voltage in response to a magnetic field. In the presence of a changing magnetic field a current will be induced in the coil, producing a voltage at its output.

The voltage and current sensors 85, 86 are basically used to monitor the charge and discharge of the batteries 35. The rechargeable batteries 35 are an important component in the solar generator 10 as the batteries 35 alone are required to supply the power to the loads 60. Therefore controlling the charge or inrush charge to the batteries 35 is important to prevent excessive increases in temperature during charging of the batteries 35. Likewise, monitoring the discharge of the batteries 35 is important to ensure the life of the batteries 35. Too much discharge from the batteries 35 by the load 60 decreases the life of the battery 35 and therefore limits the available power to the load 60. The microcontroller 41 and the GPS in the solar generator 10 can be used to track the amount of sunlight received and predicts the likely amount of sunlight over the next few days based on geographical location and time of year. The microcontroller 41 can then reduce the discharge from the batteries 35 if there seems to be a danger the battery 35 will approach discharge.

The outputs of the sensors are then transferred to an analog to digital converter (ADC) pin on the microcontroller 41. The ADC simple converts the DC voltage or current sensed by the sensors 80, 81, 82, 83, 84, 85, 86 to a digital number for processing by the microcontroller 41.

The voltage regulator 45 is used by the solar charge controller 40 to step up or step down the voltage from the solar panels 30 to control and prevent overcharging of the rechargeable batteries 35. The output from the solar panels 30 needs to be regulated to prevent overcharging of the batteries 35. The regulator 45 consists of both a buck and boost converters 46, 47. The buck converter 47 (step-down converter) is a DC to DC power converter which steps down voltage (while stepping up current) from the solar panels 30 (supply) to its output or batteries 35 (load). The boost converter 47 (step-up converter) is a DC to DC power converter that steps up voltage (while stepping down current) from solar panels 30 (supply) to the batteries 35 (load).

FIG. 10 also illustrates the load 60 which can be connected to the solar generator 10, in this case the loads 60 are shown as the LED 61 and the inverter 62. While it will be obvious to those skilled in the art that any number of devices can be powered by the solar generator 10, it should therefore be understood that the present invention is not only limited to these exemplary devices or uses.

The unitary design of the solar generator 10 provides a single unit which includes the solar panels 30 which receive the solar power energy and produces the electrical potential which is stored in the batteries 35. Typically the load 60 is connected by suitable wiring to the solar generator 10. A suitable output connector system can be utilised or alternatively screw terminals may be conveniently located on the base 15 of the solar generator 10 for connecting the wiring to the load 60. The solar generator 10 provides a DC power supply for devices which can be powered by DC. The loads 60 are connected to the solar generator 10 by the output driver 63.

The output driver 63 is an electrical device which regulates the power to the load 60. Typically the output driver 63 uses pulse-width modulation (PWM) to control the power supplied to electrical devices or loads 60. Pulse-width modulation (PWM) is a modulation technique used to encode a message into a pulsing signal.

Using an LED 61 as an example, the output driver 63 would respond to the changing needs of the LED 61 by providing a constant quantity of power to the LED 61 as its electrical properties change with temperature. Without proper control an LED 61 may become too hot and unstable, therefore causing poor performance or failure. The output driver 63 generates the PWM pulses for the LED's 61. The duty cycle of the PWM pulse determines the luminous intensity of an array of LED's. Although the LED's are turning on and off to provide a net luminance, the on-off flicker is too fast for the human eye to see and the net effect is a perceived steady state glow. Because they operate at relatively low voltage levels, LEDs 61 are well suited for use with the solar generator 10.

The PWM signal from the output driver 63 is primarily used to dim the LED 61 and control the power level of the LED 61 to maintain constant output as the electrical properties change throughout the temperature increases and decreases seen by the LED 61.

As discussed above the load 60 is fed by the output driver 63 which provides a regulated DC output power to the load 60. This means that any device 60 which can be powered by DC can be powered by the solar generator 10. This also means that the load 60 may be a DC to AC converter or inverter 62 to extend the output loads to include any AC powered device.

Alternatively, the output driver 63 may also include a grid connection to provide direct grid fed AC power to the load 60 when required. For example, the control driver 63 can be connected to a grid-connected output driver for switching on the solar power generation circuit, in such a manner to provide direct grid-connected solar power generation, when the output voltage of the solar panel 30 doesn't meet the requirements of charging, storing, generating and outputting. This can be beneficial when the solar generator 10 is used to power a digital billboard.

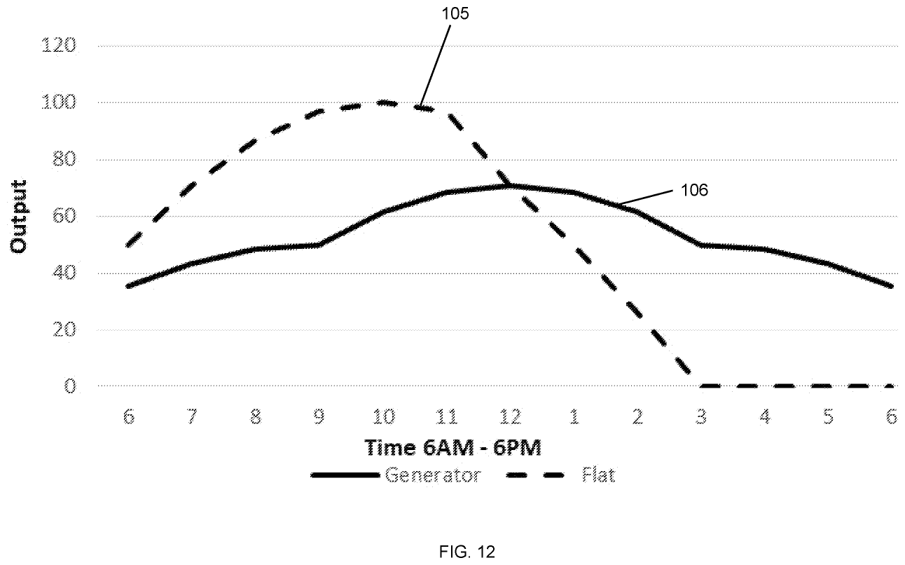

FIGS. 11, 12 and Tables 1 and 2 below illustrate the design of the solar generator 10 to optimise the power supplied from the direct sunlight 11 by the solar generator 10 and the solar panels 30 over a period of a day. Typically the sun 11 will rise and follow a path 12 over the course of the day from approximately 6.00 am to 6.00 pm as shown on the clock face 100. Table 1 below shows the output from each solar panel 30a, 30b over the duration of a day. The solar panels used in the solar generator 10 for this example are two 50 W panels 30a, 30b and the single panel 30 used in a flat orientation is a single 100 W panel. Table 2 below shows the output from a comparable single solar panel 30 system which is placed flat on a surface to receive direct sunlight during the same period. FIG. 12 illustrates a graphic representation of the output 106 of the solar generator 10 and the output 105 of the comparable single solar panel 30.

TABLE 1

| | Panel 1 50 W | | | Panel 2 50 W | | | |
|---|---|---|---|---|---|---|---|
| Time | Sun Angle | Loss | Output | Sun Angle | Loss | Output | Total |
| 6.00 am | 45 | 0.29 | 35.36 | 90 | 1.00 | 0.00 | 35 |
| 7.00 | 30 | 0.13 | 43.30 | 90 | 1.00 | 0.00 | 43 |
| 8.00 | 15 | 0.03 | 48.30 | 90 | 1.00 | 0.00 | 48 |
| 9.00 | 0 | 0.00 | 50.00 | 90 | 1.00 | 0.00 | 50 |
| 10.00 | 15 | 0.03 | 48.30 | 75 | 0.74 | 12.94 | 61 |
| 11.00 | 30 | 0.13 | 43.30 | 60 | 0.50 | 25.00 | 68 |
| 12.00 | 45 | 0.29 | 35.36 | 45 | 0.29 | 35.36 | 71 |
| 1.00 | 60 | 0.50 | 25.00 | 30 | 0.13 | 43.30 | 68 |
| 2.00 | 75 | 0.74 | 12.94 | 15 | 0.03 | 48.30 | 61 |
| 3.00 | 90 | 1.00 | 0.00 | 0 | 0.00 | 50.00 | 50 |
| 4.00 | 90 | 1.00 | 0.00 | 15 | 0.03 | 48.30 | 48 |
| 5.00 | 90 | 1.00 | 0.00 | 30 | 0.13 | 43.30 | 43 |
| 6.00 pm | 90 | 1.00 | 0.00 | 45 | 0.29 | 35.36 | 35 |

TABLE 2

| | Panel 1 100 W | | | |
|---|---|---|---|---|
| Time | Sun Angle | Loss | Output | Total |
| 6.00 am | 90 | 0.05 | 50.00 | 50.0 |
| 7.00 | 75 | 0.29 | 70.70 | 70.7 |
| 8.00 | 60 | 0.13 | 86.60 | 86.6 |
| 9.00 | 45 | 0.03 | 96.60 | 96.6 |
| 10.00 | 30 | 0.00 | 100.00 | 100.0 |
| 11.00 | 15 | 0.03 | 96.60 | 96.6 |
| 12.00 | 0 | 0.29 | 70.70 | 70.7 |
| 1.00 | 15 | 0.50 | 50.00 | 50.0 |
| 2.00 | 30 | 0.74 | 25.90 | 25.9 |
| 3.00 | 45 | 1.00 | 0.00 | 0.0 |
| 4.00 | 60 | 1.00 | 0.00 | 0.0 |
| 5.00 | 75 | 1.00 | 0.00 | 0.0 |
| 6.00 pm | 90 | 1.00 | 0.00 | 0.0 |

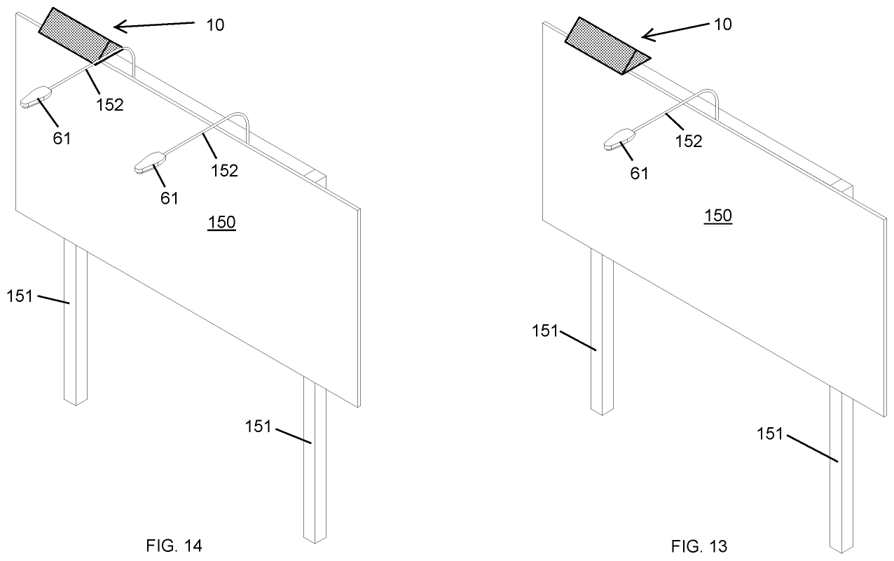

FIGS. 13 to 28 illustrate an exemplary use of the solar generator 10 for illuminating billboards 150, 155, 160 using an LED light 61. The solar power generator 10 can be used to power lighting systems used to illuminate areas in which there is difficulty connecting to a wired power grid, or where it is desired to use a renewable energy source. In order to rely on solar power to operate a lighting system, it is necessary to collect solar energy during the day, store it, and use it at night. Typically a solar generator 10 is used to charge batteries 35 during the day, which in turn power the lights at night. In order to reduce the load on the batteries 35 and provide a longer run time, light emitting diodes (LEDs) 61 that are powered from the batteries 35 have replaced conventional lights.

LEDs 61 provide illumination with an electrical energy saving typically more than 90% compared with conventional incandescent light bulbs. LEDs 61 also have an operating lifetime typically more than about 10 years. LEDs 61 operate at direct current (DC) voltages which depend on the colour of the LED 61 and the forward voltage rating of the LED 61. The LEDs 61 are driven by the control driver 63 which produces pulses of current that are pulse width modulated (PWM). The duty cycle of the PWM pulse determines the luminous intensity of an array of LED's 61

The LEDs 61 are particular useful in providing the distribution of light required to light the billboards 150, 155, 160. The LED lights 61 used to illuminate the billboards 150, 155, 160 typically require a 12 V DC power supply and provide a colour temperature of between 2700 K and 6500 K. The colour temperature of a light source is the temperature of an ideal black-body radiator that radiates light of a colour comparable to that of the light source and is conventionally expressed in kelvin, using the symbol K, a unit of measure for absolute temperature. The LED lights 61 are formed as a lightweight aluminium cast frame and have in-built heat dispersion flutes in the light casing. The light emitting diodes in the LED lights 61 are formed in a multi-focal array to provide the light distribution required to illuminate the billboards 150, 155, 160.

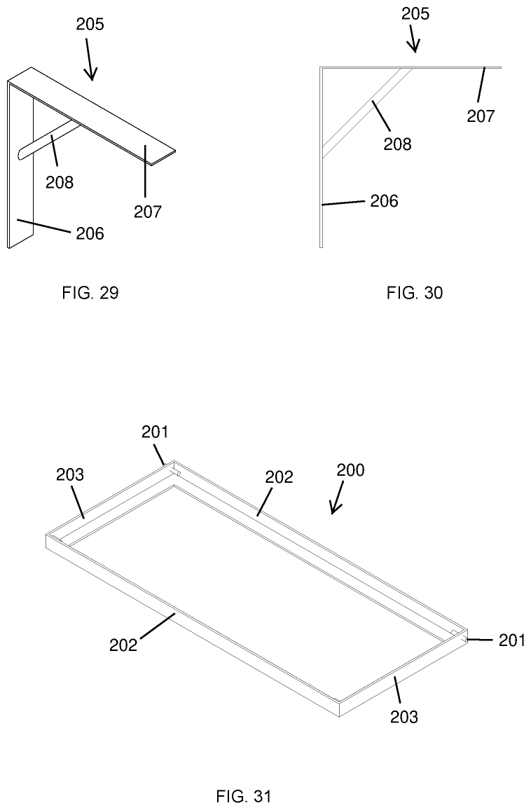

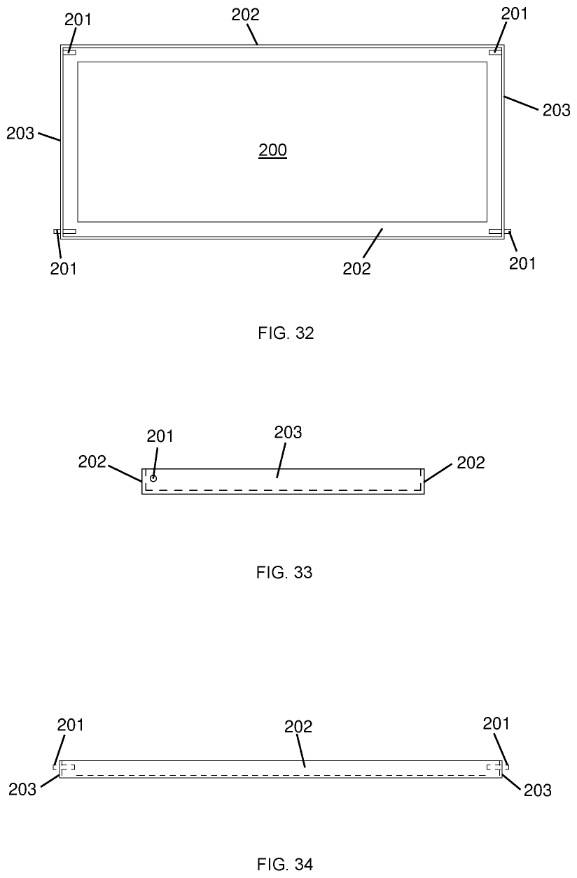

The billboards 150, 155, 160 illustrated in FIGS. 13 to 28 show a number of different size billboards as well as a number of different shape and configurations of the billboards 150, 155, 160. Each billboard 150, 155, 160 has at least one display surface which has a top and bottom edge. Each billboard 150, 155, 160 is mounted to at least one post 151, 161 but preferably two posts 151, 161. The solar generator(s) 10 are mounted using the mounting assembly of FIGS. 29 to 34 to a post 151, 161 or an associated billboard frame. The solar generator(s) 10 are typically mounted on the top edge of the billboard display surface or alternatively in a position adjacent the top of the billboard but located behind the top edge of the billboard. While the billboards 150, 155, 160 are shown with the posts 151, 161 mounted into the ground or underlying surface 300, the posts 151, 161 could also be attached to the side of buildings or road structures depending upon the desired position of the billboard.

The LED lights 61 extend from the top edge of the display surface and are typically mounted to an end of a galvanised steel pipe 152, 162. The end mounting on the LED light 61 being adjustable to ensure that the light is correctly positioned to illuminate the display surface of the billboard 150, 155, 160.

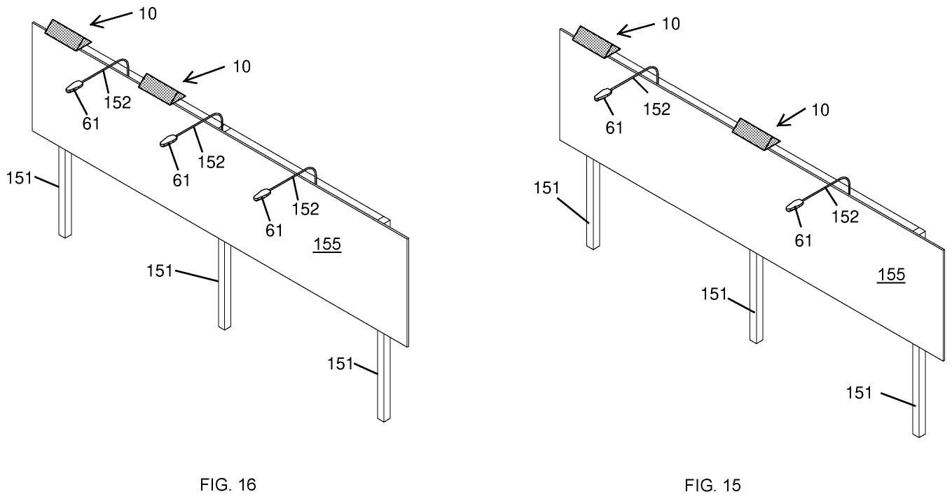

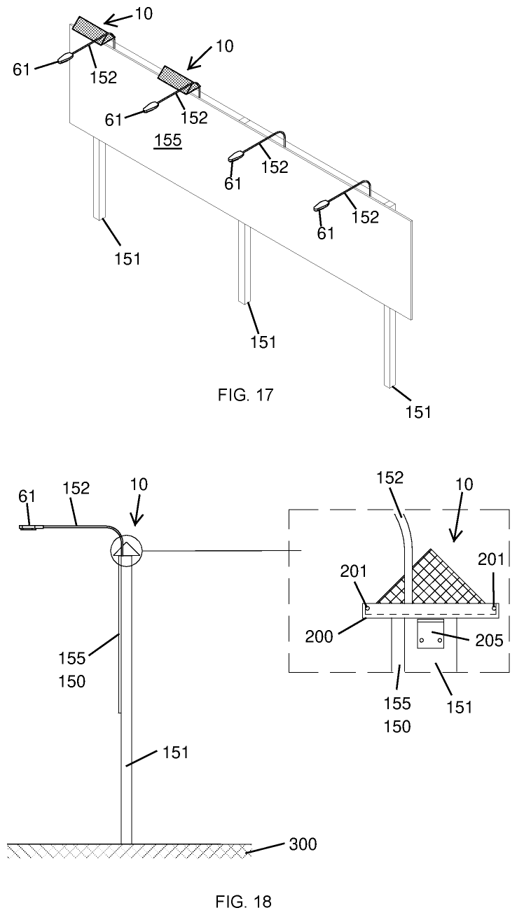

FIGS. 13 and 14 show a single sided 6 m×3 m display surface with a single solar generator 10 powering a single LED light 61 in FIG. 13 and two LED lights 61 in FIG. 14. FIGS. 15 to 17 show a single sided 12 m×3 m display surface with two solar generators 10 supplying power to two LED lights 61 in FIG. 15, three LED lights 61 in FIG. 16 and four LED lights in FIG. 17.

FIG. 18 shows a side view and detailed mounting view of the solar generators 10 used in the single sided billboards of FIGS. 13 to 17. The solar generator 10 is mounted to the top of one of the posts 151 using the mounting assembly. The mounting assembly consists of the frame 200 which is mounted to the post 151 by the bracket 205. The frame 200 also has locking pins 201 located adjacent each corner of the rectangular frame 200. The locking pins 201 are received within sockets in each corner of the solar generator 10 to securely mount the solar generator 10 to the billboards 150, 155. Alternatively, the locking pins could be located on the solar generator 10 and the sockets or apertures could be located in the frame 200. Other forms of locking mechanism could be used to secure the solar generator 10 to the frame 200.

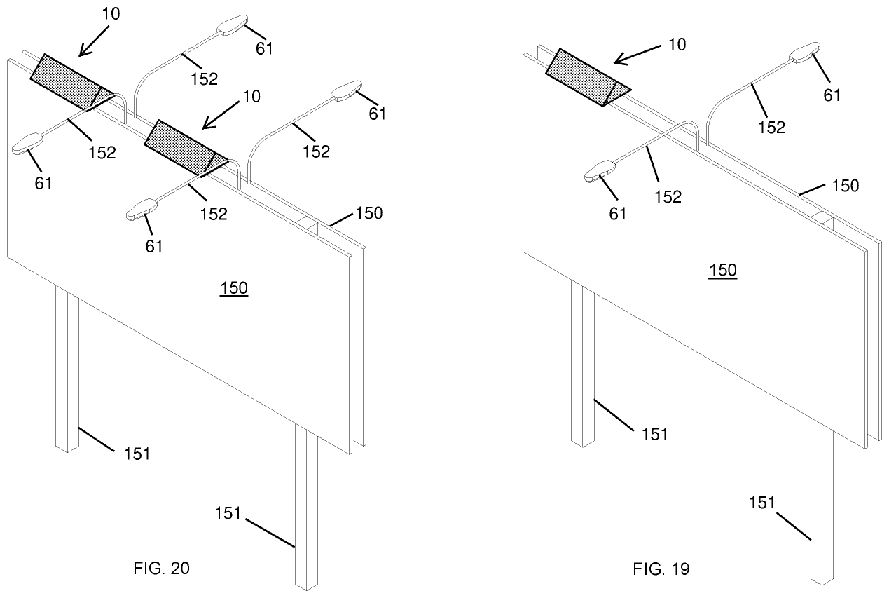

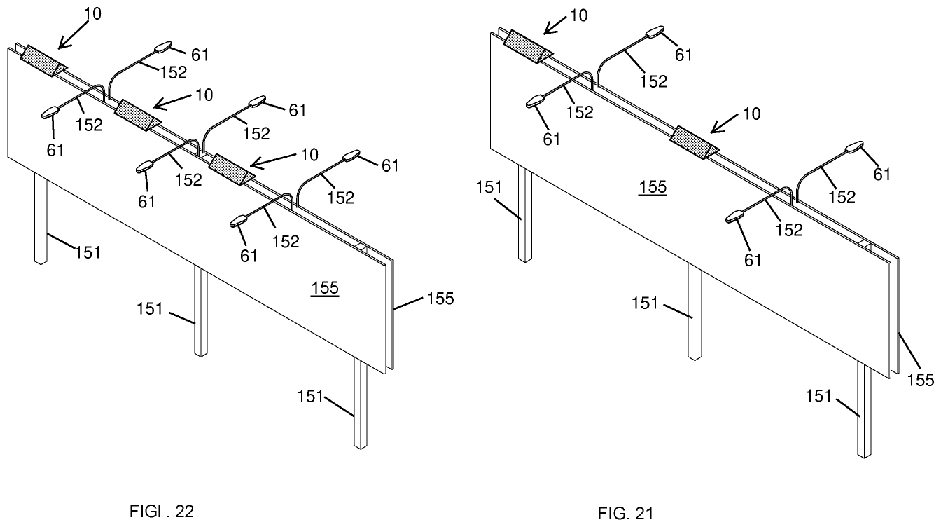

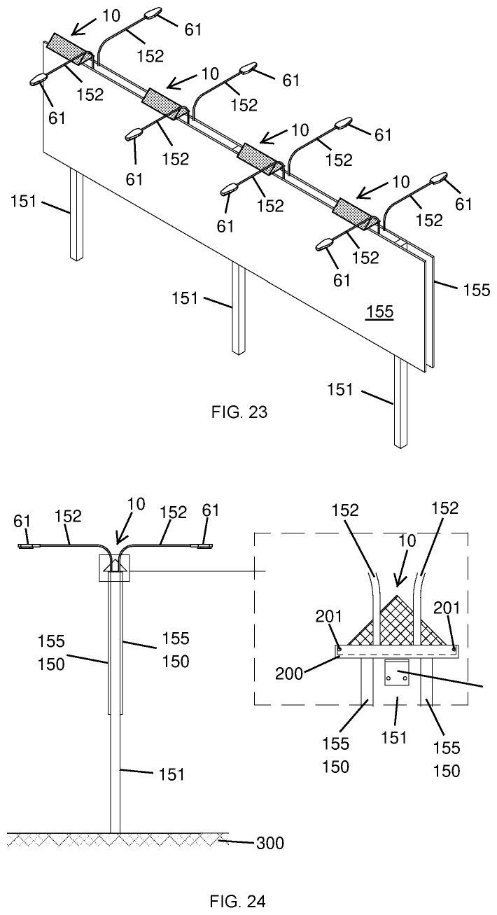

FIGS. 19 and 20 show a double sided 6 m×3 m display surface with a single solar generator 10 powering two LED lights 61 in FIG. 19 and two solar generators 10 and four LED lights 61 in FIG. 20. FIGS. 21 to 23 show a double sided 12 m×3 m display surface with two solar generators 10 supplying power to four LED lights 61 in FIG. 21, three solar generators 10 supplying six LED lights 61 in FIG. 22 and four solar generator 10 supplying eight LED lights 61 in FIG. 23.

FIG. 24 shows a side view and detailed mounting view of the solar generators 10 used in the double sided billboards of FIGS. 19 to 23. As previously described in relation to FIG. 18 the same mounting assembly is utilised for the double sided billboard.

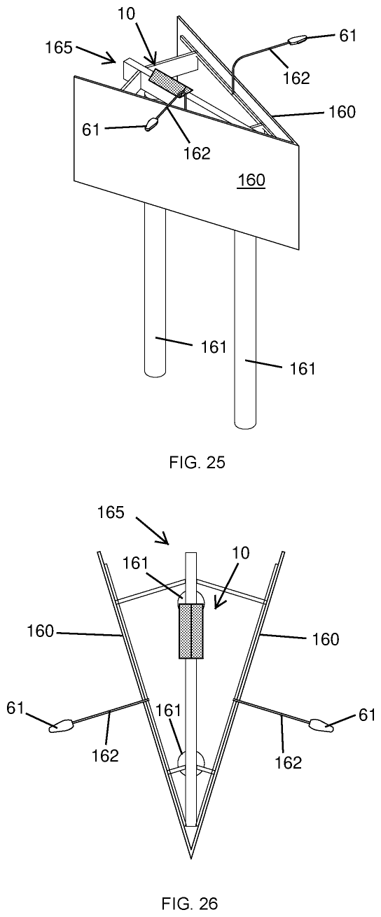

FIGS. 25 to 28 show a V-shaped dual billboard includes a first and second billboard facade 160. The V-shaped configuration is a common billboard structure and the particular angle between the two billboards 160 is not essential to the present invention. The billboard facades 160 are supported by a frame structure 165, which is secured to and supported by posts or upright columns 161. The frame structure 165 includes a variety of transverse, longitudinal, and vertical beams and rails. As illustrated in FIGS. 25 and 26 the solar generator 10 is mounted to post 161 and positioned running parallel with and along one of the beams of the support structure 165. The same mounting assembly is used as was described with relation to FIGS. 18 and 24. The LED lights 61 extend from the top edge of the display facade and are mounted to an end of a galvanised steel pipe 162.

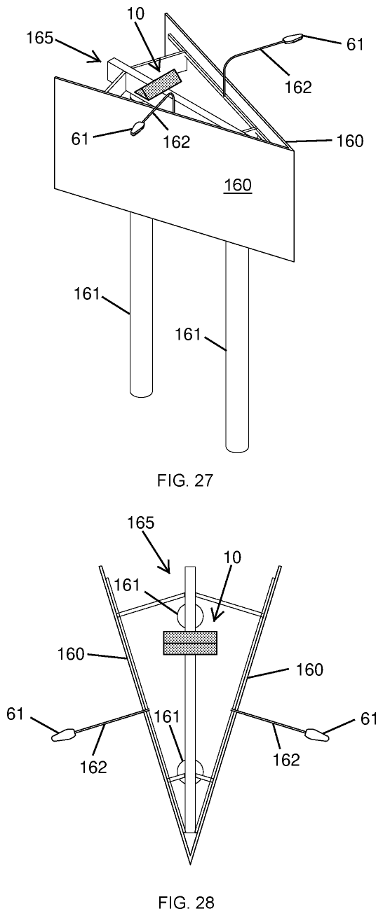

FIGS. 27 and 28 show an alternative mounting of the solar generator 10 which in this case is mounted perpendicular to the support beam of the support structure 165.

FIGS. 29 to 34 illustrate one embodiment of the mounting assembly used to mount the solar generator 10 to an infrastructure. The mounting assembly consists of a metal bracket 205 and a metal mounting frame 200. The bracket 205 is right angle or L-shaped bracket formed of two arms 206, 207 extending away and joined to each other at one end and with opposite open ends. The vertical arm 206 is fixed to one of the posts 151, 161, and its horizontal arm 207 protrudes outwards and attaches to a surface of the frame 200. The arms 206, 207 have apertures for receiving fasteners to secure the respective arms 206, 207 to the post 151, 161 or frame 200. To enable the horizontal arm 207 to support a greater weight, the bracket 205 has a third arm 208 running diagonally between the horizontal and vertical arms 206, 207. The third arm 208 providing a reinforcing element for the bracket 205.

The frame 200 is a rectangular shaped frame 200 formed by L-shaped galvanised metal bars with two long side lengths 202 joined at right angles with two short side lengths 203. Adjacent each corner and located on the short side lengths 203 are locking pins 201. When the solar generator 10 is located within the frame 200 the locking pins 201 are received within apertures or sockets located in the corresponding corners of the solar generator housing 20. Alternatively, the locking pins may be located on the solar generator 10 and the apertures or sockets on the frame 200. The locking pins 201 are designed to secure the solar generator 10 from being removed from the frame 200. Therefore some form of locking mechanism is utilised to prevent the locking pins 201 from releasing the solar generator 10. For example, this could simply be a mechanical lock on the locking pins 201 to prevent them from being released from the solar generator 10 sockets.

While the above embodiment has been described for securing the solar generator 10 to the infrastructure other devices and methods for securing the solar generator are not excluded. For example, the mounting plate 17 located on the base 15 of the solar generator 10 may also include a spigot which can be received within a socket on a post 151, 161 and a locking mechanism utilised to secure the solar generator 10 to the post 151, 161.

The core components in all of these systems are the solar panels 30 positioned on the right triangular prism housing 20, rechargeable storage batteries 35, and the load 60. The behaviour of each element must be compatible with that of the others. In this case, that means the output voltage/current behaviour of the solar panels 30 must align with the battery charging profile 35. In other words, the solar panels 30 must put out enough energy at the right level to charge the battery 35. And the battery discharge profile must match the load requirements and in the case of the LED lights 61 must match the LED drive requirements. In other words, the battery 35 must put out enough energy at the right level to run the LED light 61 for the required time.

This is achieved through the design of the housing 20 such that the solar panels 30 are mounted to receive the optimum amount of daily sunlight available to enable the batteries 35 to be charged and then supply the power to the LED lights 61 at night. The solar generator 10 is a unitary design which includes the solar panels 30, the right triangular prism housing 20, the solar charge controller 40 and the batteries 35 all in the one unit.

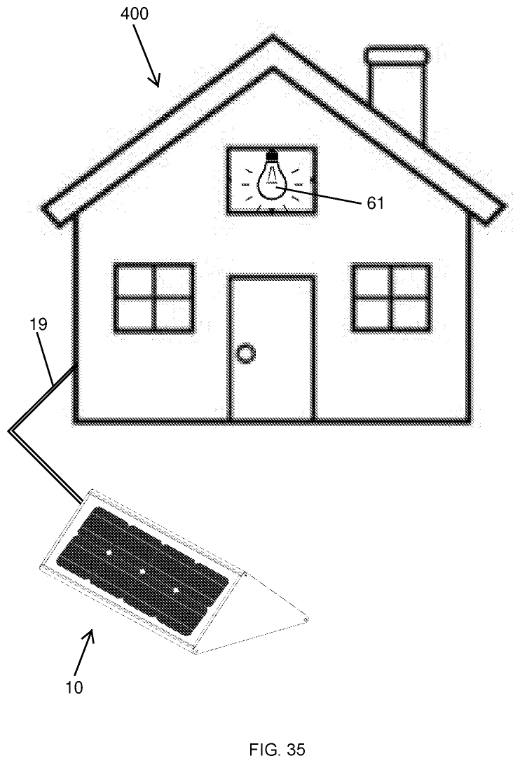

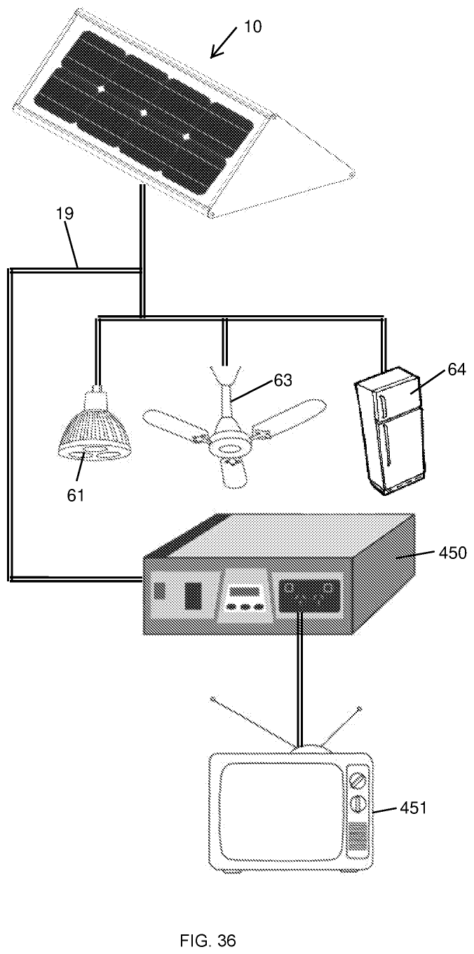

Due to the portable nature of the present invention, the solar generator 10 is also useful as an emergency power supply as illustrated in FIG. 35. These emergency situations can occur simply due to power outages or due to natural disasters such as but not limited to, storms, earthquakes and accidents. In these situations the solar generator 10 can be used as an emergency power supply for a house 400. The solar generator 10 is shown connected to the house 400 by electrical cable 19 to power the light 61. Obviously other devices can be powered by the solar generator 10 and some of these are shown in FIG. 36. The solar generator 10 can be used to power such DC loads as LED lights 61, fans 63 and refrigerators 64. Alternatively, if a DC to AC inverter 450 is connected to the solar generator 10 other AC powered devices such as the television 451 can also be powered. The above examples of powered devices is not only limited to these devices and can include any DC or AC powered device.

The solar generator 10 is also useful during emergency relief situations, military deployment situations, on construction sites, and in remote locations far from population centres, where there will always be problems with the supply of reliable power and water treatment solutions. The solar generator 10 can be used to provide temporary power by generating a large amount of electrical power solutions at an isolated location quickly.

The present invention provides a solar generator 10 which is designed to be portable and therefore is lightweight and easily handled by a single user. The solar generator 10 can be simply set up on any flat or inclined surface and facing into the direction of the sun. The solar panels 30 will charge the batteries 35 during the daylight hours and then supply power to loads during the night.

The solar generator housing 20 has an aluminium frame with stainless steel fittings and fastenings. The solar panels 30 are fitted to the two equal length sides of the housing 20 and have an aluminium frame with a tempered glass top providing a toughened outer shell of the solar panels 30. The base 15 is an aluminium sheet which is perforated to allow for airflow and closes the internal volume of the solar generator 10 to provide a waterproof enclosure with an IP67 ingress rating.

### ADVANTAGES

In essence, embodiments of the present invention stem from the requirement for a solar powered DC power supply in which a solar panel is purposely mounted to provide a high efficiency DC power supply which could be utilised to provide DC lighting for billboards, displays and the like.

The solar generator of the present invention provides a scalable generator which provides more output by using more than one generator connected in series or parallel. The angular placement of the solar panels on the equal length sides of the right triangular prism improves the efficiency of the solar panel system.

The present invention also provides advantages over the known prior art in that a unitary fully contained solar generator is provided that utilises the renewable energy of the sun to produce energy to charge the batteries and provide power to a load.

The present invention has been found to be particularly useful in providing a renewable energy source for billboards where there is little or no grid connection possible or a renewable energy source is preferred. In particular, the supply of electricity to remote areas has always been a challenge for utilities mainly due to the cost of maintaining remote infrastructure which is much higher per customer than in more densely populated urban areas. The solar generator of the present invention provides an economic alternative.

The present invention also provides an alternative for power supply during emergency relief situations, military deployment situations, on construction sites, and in remote locations far from population centres. The portability and lightweight solar generator provides a reliable power supply and power for water treatment solutions. The present invention provides a transportable solar generator with a means for generating a large amount of electrical power solutions at an isolated location quickly.

### VARIATIONS

It will be realized that the foregoing has been given by way of illustrative example only and that all other modifications and variations as would be apparent to persons skilled in the art are deemed to fall within the broad scope and ambit of the invention as herein set forth.

As used herein the term “and/or” means “and” or “or”, or both.

As used herein “(5)” following a noun means the plural and/or singular forms of the noun.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the scope of the above described invention.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

1. A unitary, self-contained solar generator for converting solar power energy into electrical power, the unitary, self-contained solar generator comprising:
a housing shaped as a right triangular prism and having a first and a second parallel and congruent triangular end faces and rectangular faces formed perpendicular to and between the triangular faces, defining an interior volume;
a base formed on one of the rectangular faces;
a solar panel mounted on at least two of the rectangular faces, the at least two rectangular faces forming two equal length sides extending from the base;
at least one solar charge controller electrically connected to the solar panels;
one or more rechargeable batteries electrically connected to the at least one solar charge controller;
a power outlet electrically connected to the at least one solar charge controller, wherein the power outlet is adapted to distribute electricity stored within the one or more rechargeable batteries; and
wherein the at least one solar charge controller and the batteries are mounted on the base within the interior volume of the housing.

2. (canceled)

3. (canceled)

4. A unitary, self-contained solar generator as claimed in claim 1, wherein the base is adapted to allow the solar generator to be mounted to a mounting assembly, the mounting assembly being attached to an infrastructure, the mounting assembly having a frame and at least one bracket for mounting the frame to the infrastructure.

5. (canceled)

6. A unitary, self-contained solar generator as claimed in claim 4, wherein the base and frame have complementary locking devices adapted to secure the base and the solar generator to the frame.

7. A unitary, self-contained solar generator as claimed in claim 6, wherein the mounting assembly comprises a spigot mounted to the base for attaching the base to a complementary socket mounted on the infrastructure, the spigot and socket forming a locking mechanism to securely retain the solar generator to the infrastructure.

8. (canceled)

9. A unitary, self-contained solar generator as claimed in claim 1, wherein the base and at least one of the triangular faces further comprise a plurality of apertures to allow airflow through the housing to ensure an internal temperature of the batteries and the solar charger controller are maintained at an acceptable level.

10. A unitary, self-contained solar generator as claimed in claim 9, further comprising an insect screen covering all internal faces of the housing to prevent the ingress of insects into the interior volume of the solar generator, an apex formed between the mounted solar panels is adapted to receive a bird wire animal deterrent mechanism, and has an ingress protection rating of IP67.

11. (canceled)

12. (canceled)

13. (canceled)

14. A unitary, self-contained solar generator as claimed in claim 1, wherein the solar panels comprise a plurality of solar cells, the solar cells being either a monocrystalline or polycrystalline cells, and the solar panels have a tempered glass top layer and are mounted into an aluminium frame for strength and waterproofing.

15. (canceled)

16. A unitary, self-contained solar generator as claimed claim 1, wherein the housing is constructed from an aluminium extruded frame, the frame being adapted to receive the solar panels, the base and the triangular end faces to form the housing with the internal volume.

17. A unitary, self-contained solar generator as claimed in claim 1, wherein the one or more rechargeable batteries are a lithium-ion polymer battery or the like, and comprise at least one temperature sensor, the temperature sensor being adapted to prevent the overheating of the batteries due to overcharging of the batteries.

18. (canceled)

19. A unitary, self-contained solar generator as claimed in claim 1, wherein the at least one solar charge controller is adapted to regulate the voltage of the electricity supplied to the one or more rechargeable batteries.

20. A unitary, self-contained solar generator as claimed in claim 19, wherein the at least one solar charge controller comprises:
a Wi-Fi enabled microcontroller that enables wireless local area networking connectivity for the solar generator to send and receive data and accept commands over the internet, the microcontroller comprising a microprocessor, a memory and at least one input/output port to allow a user to perform a firmware update;
a regulator for controlling the charge to the rechargeable batteries;
a monitoring system adapted to monitor the voltage and current from the solar panels, monitor the voltage and current on the batteries, monitor the temperature of the batteries and control the charge and discharge of the batteries by monitoring a load connected to the power outlet;
a GPS receiver that is capable of receiving information from a GPS satellite to calculate the solar generators geographical position; and
an on/off switch or circuit breaker for isolating the solar generator.

21. (canceled)

22. (canceled)

23. A unitary, self-contained solar generator as claimed in claim 20, wherein the on/off switch or circuit breaker for isolating the solar generator is a mechanical switch located on an outer surface of the housing or an electronic switch which is adapted to be remotely controlled.

24. (canceled)

25. (canceled)

26. (canceled)

27. A unitary, self-contained solar generator as claimed in claim 1, wherein the at least one solar charge controller further comprises a driver circuit adapted to control the voltage to the power outlet, the driver circuit is a DC to DC converter designed as a step up or a step down voltage controller to the power outlet.

28. (canceled)

29. A unitary, self-contained solar generator as claimed in claim 27, wherein the driver circuit is an LED driver circuit configured to provide stored electrical energy from the rechargeable batteries to at least one LED, the LED driver circuit comprises an under voltage protection circuit configured to shut off operation of the at least one LED when a voltage from the rechargeable batteries drops below a predetermined voltage level and an overdriving protection circuit to prevent overdriving of the at least one LED.

30. (canceled)

31. A unitary, self-contained solar generator as claimed in claim 14, wherein the at least one solar charge controller further comprises a wireless communication connection for connecting the solar generator to the internet to allow the solar generator to send and receive data and receive control commands over the internet, the wireless connection is provided by any one of a Bluetooth connection through a Bluetooth radio, a wireless local area network transceiver using a Wi-Fi connection or a microwave connection using a microwave transceiver.

32. A unitary, self-contained solar generator as claimed in claim 1, wherein the power outlet of the solar generator is provided with a DC voltage to a load, the load is selected from any one or more of the group consisting of:
(i) an LED light;
(ii) a DC to AC inverter; or
(iii) any DC powered load.

33. (canceled)

34. (canceled)

35. (canceled)

36. (canceled)

37. A unitary, self-contained solar generator as claimed in claim 32, wherein the solar generator further comprises application software residing on a mobile computing device, the application software is adapted to i) send and receive data from the solar generator monitoring system, (ii) send control commands to the solar generator, (iii) receive information from the GPS receiver to calculate the solar generators geographical position, and (iv) update the firmware on the microcontroller.

38. An outdoor advertising structure comprising
at least one unitary, self-contained solar generator comprising:
a housing shaped as a right triangular prism and having a first and a second parallel and congruent triangular end faces and rectangular faces formed perpendicular to and between the triangular faces, defining an interior volume;
a base formed on one of the rectangular faces;
a solar panel mounted on at least two of the rectangular faces, the at least two rectangular faces forming two equal length sides extending from the base;
at least one solar charge controller electrically connected to the solar panels;
one or more rechargeable batteries electrically connected to the at least one solar charge controller;
a power outlet electrically connected to the at least one solar charge controller, wherein the power outlet is adapted to distribute electricity stored within the one or more rechargeable batteries; and
wherein the at least one solar charge controller and the batteries are mounted on the base within the interior volume of the housing;
a support structure, the support structure comprises at least one pole or post supported in the ground or mounted to another supporting structure;
a display surface mounted on the support structure, the display surface having an upper edge and a lower edge and visual media content is displayed thereon;
at least one light attachment means extending from the upper edge of the display surface; and
at least one light emitting diode (LED) light adapted to be attached to an end of the light attachment means and powered by the at least one unitary, self-contained solar generator mounted to the upper edge of the display surface and arranged to direct light across the display surface.

39. (canceled)

40. (canceled)

41. (canceled)

42. (canceled)

43. (canceled)

44. An outdoor advertising structure as claimed in claim 38, wherein the at least one unitary, self-contained solar generator charge controller is configured to monitor the total amount of solar energy supplied to the rechargeable batteries during daytime and configured to calculate an amount of electrical power to be supplied from the rechargeable batteries to the at least one LED light so that the at least one LED light operates at a relatively constant level of LED output brightness during substantially all the entire night time hours.

45. An outdoor advertising structure as claimed in claim 44, wherein the outdoor advertising structure is connected to an AC power supply, and the outdoor advertising structure is a digital billboard, the digital billboard being powered by the at least one unitary, self-contained solar generator and/or the AC power supply.

46. (canceled)

47. (canceled)

48. (canceled)

49. (canceled)
